(19) United States
(12) Patent Application Publication
(10) Pub. No.: US 2026/0014597 A1
(43) Pub. Date: Jan. 15, 2026

(54) MULTI-PROCESS SELF-CLEANING DEVICE

(71) Applicant: Microchip Technology Incorporated, Chandler, AZ (US)

(72) Inventors: Patrick McFarland, Gilbert, AZ (US); Steve Nagel, Chandler, AZ (US); Bomy Chen, Newark, CA (US); Arthur B. Eck, Gilbert, AZ (US)

(73) Assignee: Microchip Technology Incorporated, Chandler, AZ (US)

(21) Appl. No.: 18/899,769

(22) Filed: Sep. 27, 2024

Related U.S. Application Data
(60) Provisional application No. 63/669,403, filed on Jul. 10, 2024.

(51) Int. Cl. B08B 7/02; B08B 7/00; B08B 7/04

(52) U.S. Cl. CPC B08B 7/02; B08B 7/0071; B08B 7/04

(57) ABSTRACT

An example of the teachings herein includes a system comprising: a sensor element; a mechanical transducer to vibrate the sensor element; and a heating element to provide localized heat to the sensor element. The heating element and the mechanical transducer operate in concert to raise a temperature of the sensor element and vibrate the sensor element to dislodge contaminants from a surface of the sensor element.

### PRIORITY STATEMENT

This application claims priority to U.S. Provisional Patent Application No. 63/669,403 filed Jul. 10, 2024, the contents of which are hereby incorporated in their entirety.

### FIELD OF THE INVENTION

The present disclosure relates to electronic devices, including monitors and sensors. Various examples of the teachings herein include systems and/or methods for cleaning monitors and/or sensors.

### BACKGROUND

In the field of electronic devices, a build-up of dust and debris may adversely affect the operation of said devices. For example, such build-up may reduce the accuracy of sensor readings and/or the effectiveness of a monitor. Failure to reduce and/or remove such contamination reduces accuracy and lifespan of the sensor elements and/or entire devices. The operation of environmental sensors such as smoke detectors and other life safety monitors may be compromised beyond acceptable safety limits.

Cleaning electronic devices by hand may be time-consuming and/or otherwise complicated. For instance, in some monitors cleaning requires accessing an interior portion. Various self-cleaning devices may incorporate mechanical means such as air movement to remove some forms of contamination. In some cases, however, dust or debris may form a chemical bond with a portion of a sensor or monitor and these mechanical cleaning means are unlikely to fully clean the sensor.

For the purposes of this disclosure, a monitor refers to an electronic device which monitors one or more conditions, such as a smoke detector or a thermostat. A sensor refers to a specific element within such a monitor which detects a particular parameter or condition.

### BACKGROUND

Some examples of the teachings herein include systems and/or methods for cleaning monitors and/or sensors. As an example, a system may include: a sensor; a mechanical transducer to vibrate the sensor; and a heating element to provide localized heat to the sensor; wherein the heating element and the mechanical transducer operate in concert to raise a temperature of the sensor and vibrate the sensor to dislodge contaminants from a surface of the sensor.

As another example, a system may include: a sensor; a housing surrounding the sensor to reduce contamination reaching the sensor; a mechanical transducer to vibrate the housing; and a heating element to provide localized heat to the housing; wherein the heating element and the mechanical transducer operate in concert to raise a temperature of the housing and vibrate the housing to dislodge contaminants from a surface of the housing.

As another example, a method for cleaning a sensor may include: vibrating the sensor with a mechanical transducer; and providing localized heat to the sensor with a heating element to raise a temperature of the sensor; wherein the mechanical transducer and the heating element are operated in concert to dislodge contaminants from a surface of the sensor.

### BRIEF DESCRIPTION OF THE DRAWINGS

FIG. 1 illustrates one of various examples of an apparatus incorporating teachings of the present disclosure;

FIG. 2 illustrates one of various examples of an apparatus incorporating teachings of the present disclosure;

FIG. 3 illustrates one of various examples of an apparatus incorporating teachings of the present disclosure;

FIG. 4 illustrates one of various examples of an apparatus incorporating teachings of the present disclosure; and

FIG. 5 illustrates one of various examples of an apparatus incorporating teachings of the present disclosure.

### DETAILED DESCRIPTION

Life safety or environmental monitors may contain one or more sensor elements as well as a piezoelectric transducer and/or a speaker. For example, some devices incorporate a speaker to provide an alarm during an emergency and/or in response to other sensed conditions. A transducer may be driven in a particular frequency range to provide audible signals. The same transducer may be driven in a second frequency range outside of human hearing and, in that second range, provide mechanical vibration to the sensor or other components of the device without providing an audible signal. Of course, the first frequency range may also provide mechanical vibration as well as an audible signal.

Monitors incorporating teachings of the present disclosure may include a heating element to provide localized heat to the sensor element. In the monitor, the sensor element and a surrounding body or housing of the monitor may comprise different materials. In some examples, the sensor element and the housing have different thermal expansion coefficients as a result. In such examples, the heating element may be operated to raise the temperature of the sensor element. The resulting thermal expansion and/or change in temperature may weaken any bond between the sensor and a contaminant such as dust.

Examples of the teachings herein include monitor systems with coordinated operation of a transducer and a heating element. The combination of vibration and localized heating may operate to improve removal of contaminants from the sensor element and/or the system by dislodging dust, debris, or other contaminants. In some examples, the sensor element is oriented within a housing such that the force of gravity acts to remove contaminants from the sensor element as well. Application of these teachings may improve the lifespan of the sensor element or the system as a whole as well as the effectiveness and/or accuracy during the lifespan while avoiding maintenance costs and labor.

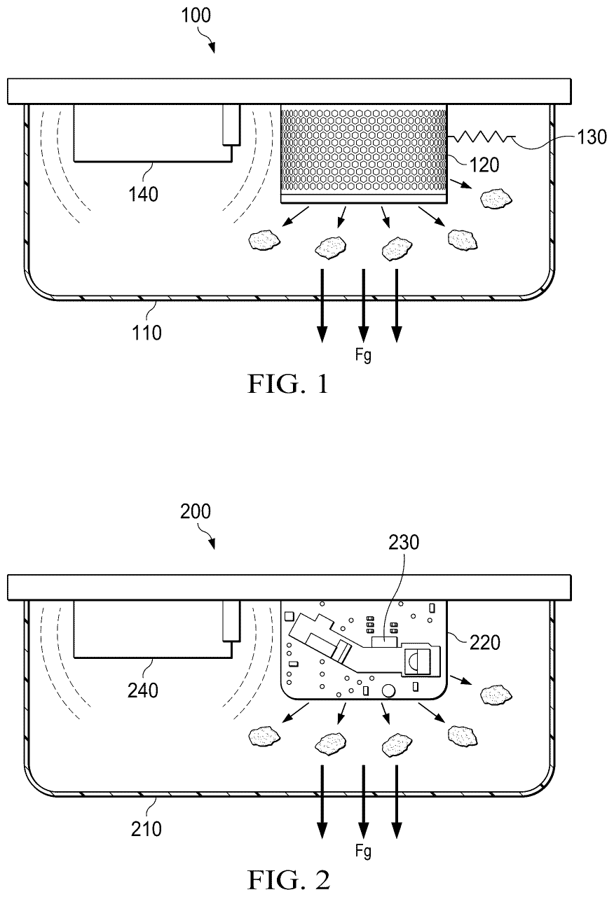

FIG. 1 illustrates one of various examples of a system 100 incorporating teachings of the present disclosure. System 100 may include a housing 110, a mesh 120, a heating element 130, and a transducer 140.

The housing 110 may include any combination of inlets or outlets appropriate for allowing air flow into an interior of the housing 110. The housing 210 may define a test chamber in the interior of the housing separated from other components not shown in FIG. 2. A sensor may be mounted in the interior of the housing 110 and operate to detect one or more parameters of interest. For example, some systems 100 may include one or more sensors operating to detect smoke entering the interior of the housing 110. The example shown in FIG. 1 may be referred to as a photochamber-type smoke detector.

The sensor elements may monitor any appropriate parameter and may operate under any appropriate scheme, including without limitation by measuring a capacitance, a current, a resistance, etc. The sensor may be mounted inside a further protective guard or mesh 120. As shown in FIG. 1, the mesh 120 comprises an insect mesh which may comprise a metal or other appropriate material. The mesh 120 may operate to prevent insects and/or dust from contaminating the sensor element(s) therein. In the example shown in FIG. 1, the mesh 120 may define the test chamber for the system 100.

The heating element 130 may be mounted in the interior of the housing 110 and operate to provide heat to the mesh 120.

The transducer 140 may be mounted in the interior of the housing 110. In some examples, the transducer 140 may be mounted to a mounting surface of the housing 110 or of another elements of the system 100. The transducer 140 may operate to vibrate at a selected frequency and thereby deliver mechanical and/or acoustic vibrations to the mesh 120. The transducer 140 may include any element operable to create a mechanical vibration. For example, the transducer 140 may include a speaker to provide an alarm during an emergency and/or in response to other conditions sensed by the sensor(s). The transducer 140 may be driven in a particular frequency range to provide audible signals. The transducer 140 may be driven in a second frequency range outside of human hearing and, in that second range, provide mechanical vibration to the insect mesh 120 or other components of the device.

In operation, the system 100 may operate to apply heat and vibration to the guard 120 at the same time. In this manner, dirt, insects, and/or other contaminants may be dislodged from the mesh 120. As shown in FIG. 1, if the mesh 120 is mounted at the top of the housing 110, the force of gravity may also operate to remove contaminants from the mesh 120 once dislodged by the operation of the system 100.

FIG. 2 illustrates one of various examples of a system 200 incorporating teachings of the present disclosure. System 200 may include a housing 210. a sensor package 220, a heating element 230, and a transducer 240.

The housing 210 may include any combination of inlets or outlets appropriate for allowing air flow into an interior of the housing 210. The housing 210 may define a test chamber in the interior of the housing separated from other components not shown in FIG. 2.

A sensor package 220 may be mounted in the interior of the housing 210 and operate to detect one or more parameters of interest. For example, some systems 200 may include a sensor package 220 operating to detect smoke entering the interior of the housing 210. In that example, the sensor package 220 may include one or more photodiodes and one or more light emitting diodes (LED) operating to detect smoke particles in the interior of the housing 210. The example shown in FIG. 2 may be referred to as a photochamber-type smoke detector.

The heating element 230 may be mounted on the same circuit board that holds the sensor package 220. The heating element 230 may operate to provide heat to the LEDs or the photodiodes in the sensor package 220.

The transducer 240 may be mounted in the interior of the housing 210. The transducer 240 may operate to vibrate at a selected frequency and thereby deliver mechanical and/or acoustic vibrations to the sensor package 220. The transducer 240 may include any element operable to create a mechanical vibration. For example, the transducer 240 may include a speaker to provide an alarm during an emergency and/or in response to other conditions sensed by the sensor(s). The transducer 240 may be driven in a particular frequency range to provide audible signals. The transducer 240 may be driven in a second frequency range outside of human hearing and, in that second range, provide mechanical vibration to the sensor package 220 or other components of the device.

In operation, the system 200 may operate to apply heat and vibration to the sensor package 220 at the same time. In this manner, dirt, insects, and/or other contaminants may be dislodged from the sensor package 220. As shown in FIG. 2, if the sensor package 220 is mounted at the top of the housing 210, the force of gravity may also operate to remove contaminants from the sensor package 220 once dislodged by the operation of the system 200.

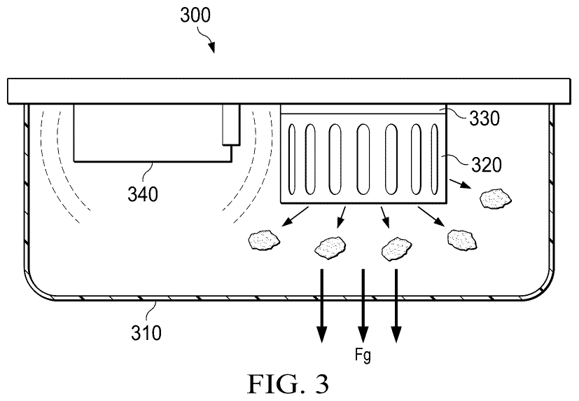

FIG. 3 illustrates one of various examples of a system 300 incorporating teachings of the present disclosure. System 300 may include a housing 310, an internal housing 320, a heating element 330, and a transducer 340.

The housing 310 may include any combination of inlets or outlets appropriate for allowing air flow into an interior of the housing 310. The housing 310 may define a test chamber in the interior of the housing separated from other components not shown in FIG. 3. A sensor may be mounted in the interior of the housing 310 and operate to detect one or more parameters of interest. For example, some systems 300 may include one or more sensors operating to detect smoke entering the interior of the housing 310. The example shown in FIG. 3 may be referred to as a ionization-type smoke detector.

The sensor elements may monitor any appropriate parameter and may operate under any appropriate scheme, including without limitation by measuring a capacitance, a current, a resistance, etc. The sensor may be mounted inside a further internal housing 320. As shown in FIG. 3, the internal housing comprises a metal or other appropriate material. The internal housing may operate to prevent insects and/or dust from contaminating the sensor element(s) therein. In the example shown in FIG. 3, the internal housing 320 may define the test chamber for the system 300.

The heating element 330 may operate to provide heat to the internal housing 320.

The transducer 340 may be mounted in the interior of the housing 310. The transducer 340 may operate to vibrate at a selected frequency and thereby deliver mechanical and/or acoustic vibrations to the internal housing 320. The transducer 340 may include any element operable to create a mechanical vibration. For example, the transducer 340 may include a speaker to provide an alarm during an emergency and/or in response to other conditions sensed by the sensor(s). The transducer 340 may be driven in a particular frequency range to provide audible signals. The transducer 340 may be driven in a second frequency range outside of human hearing and, in that second range, provide mechanical vibration to the internal housing 320 or other components of the device.

In operation, the system 300 may operate to apply heat and vibration to the internal housing 320 at the same time. In this manner, dirt, insects, and/or other contaminants may be dislodged from the internal housing 320. As shown in FIG. 3, if the internal housing 320 is mounted at the top of the housing 310, the force of gravity may also operate to remove contaminants from the internal housing 320 once dislodged by the operation of the system 300.

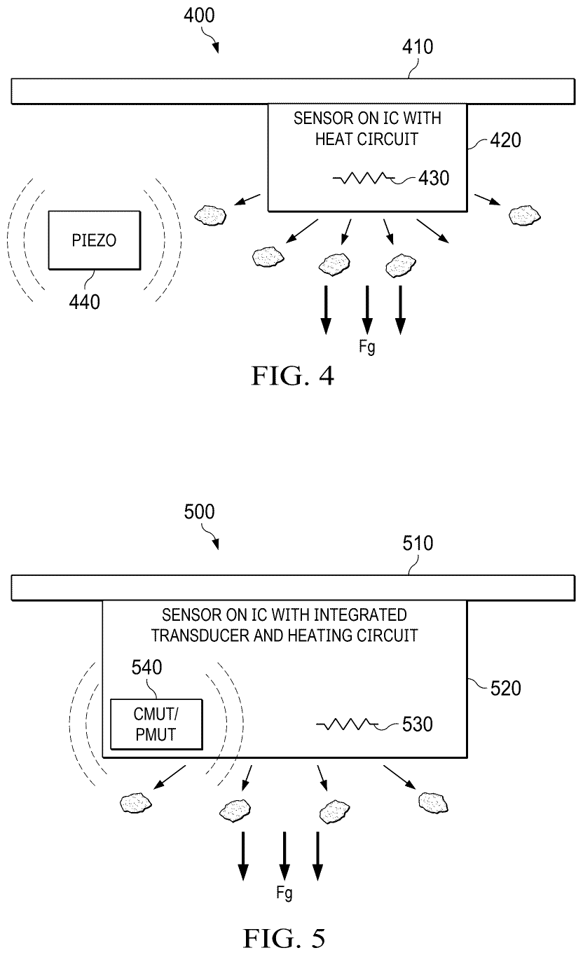

FIG. 4 illustrates one of various examples of a system 400 incorporating teachings of the present disclosure. System 400 may include a printed circuit board 410, a sensor element 420, a heating element 430, and a transducer 440.

The printed circuit board (PCB) 410 may be mounted to or in another system or housing (not shown here). The system 400 shown in FIG. 4 may be referred to as an integrated circuit-remote transducer. The printed circuit board 410 may include one or more controllers to actuate the transducer 440 and/or activate the heating element 430.

The sensor element 420 may monitor any appropriate parameter and may operate under any appropriate scheme, including without limitation by measuring a capacitance, a current, a resistance, etc. A surface of the sensor element 420 may come in contact with a particulate contaminant such as dust or debris. As shown in FIG. 4, the sensor element 420 may be part of an integrated circuit (IC).

Some example uses for system 400 may include gas and/or chemical monitoring systems. In these systems, the sensor element 420 may change resistance and/or capacitance in response to the concentration of the sensed gas and/or chemical in the area of the sensor element 420. Example gases include, but are not limited to, a carbon monoxide (CO) sensor in a life safety device, methane or nitrogen dioxide (NO₂) in agriculture, mining, and construction industries. The sensor element 420 in such a monitoring system may comprise an oxide, e.g., a metal oxide, and/or a polymer, e.g., poly(3,4-ethylenedioxythiophene) polystyrene sulfonate (PEDOT:PSS) and poly(3,4-ethylenedioxythiophene) (PEDOT). A sensor element 420 comprising a polymer may be used to sense humidity.

The heating element 430 may operate to provide localized heat to the sensor element 420. In the system 400, the sensor element 420 and the IC or the PCB 410 may comprise different materials. In some examples, the sensor element 420 and these materials may have different thermal expansion coefficients as a result. In such examples, the heating element 430 may be operated to raise the temperature of the sensor element. The resulting thermal expansion and/or change in temperature may weaken any bond between the sensor element 420 and a contaminant such as dust. In some examples, such as that shown in FIG. 4, the heating element 430 may be part of the same IC as the sensor element 420.

The transducer 440 may be mounted near the sensor element 420. For example, some systems 400 include a transducer 440 mounted on the same PCB 410 as the sensor element 420. The transducer 440 may operate to vibrate at a selected frequency and thereby deliver mechanical and/or acoustic vibrations to the sensor element 420. The transducer 440 may include any element operable to create a mechanical vibration. For example, the transducer 440 may include a speaker to provide an alarm during an emergency and/or in response to other conditions sensed by the sensor(s). The transducer 440 may be driven in a particular frequency range to provide audible signals. The transducer 440 may be driven in a second frequency range outside of human hearing and, in that second range, provide mechanical vibration to the sensor element 420 or other components of the device.

In operation, the system 400 may operate to apply heat and vibration to the sensor element 420 at the same time. In this manner, dirt, insects, and/or other contaminants may be dislodged from the sensor element 420. As shown in FIG. 4, if the sensor element 420 is mounted to hang from the PCB 410, the force of gravity may also operate to remove contaminants from the sensor element 420 once dislodged by the operation of the system 400.

FIG. 5 illustrates one of various examples of a system 500 incorporating teachings of the present disclosure. System 500 may include a printed circuit board 510, a sensor element 520, a heating element 530, and a transducer 540.

The printed circuit board 510 may be mounted to or in another system or housing (not shown here). The system 500 shown in FIG. 5 may be referred to as an integrated circuit-integrated transducer. The printed circuit board 510 may include one or more controllers to actuate the transducer 540 and/or activate the heating element 530.

The sensor element 520 may monitor any appropriate parameter and may operate under any appropriate scheme, including without limitation by measuring a capacitance, a current, a resistance, etc. A surface of the sensor element 520 may come in contact with a particulate contaminant such as dust or debris. As shown in FIG. 5, the sensor element 520 may be part of an integrated circuit (IC).

The heating element 530 may operate to provide localized heat to the sensor element 520. In the system 500, the sensor element 520 and the IC or the PCB 510 may comprise different materials. In some examples, the sensor element 520 and these materials may have different thermal expansion coefficients as a result. In such examples, the heating element 530 may be operated to raise the temperature of the sensor element. The resulting thermal expansion and/or change in temperature may weaken any bond between the sensor element 520 and a contaminant such as dust. In some examples, such as that shown in FIG. 5, the heating element 530 may be part of the same IC as the sensor element 520.

The transducer 540 may also be part of the same IC as the sensor element 520. The transducer 540 may operate to vibrate at a selected frequency and thereby deliver mechanical and/or acoustic vibrations to the sensor element 520. The transducer 540 may include any element operable to create a mechanical vibration. For example, the transducer 540 may include a speaker to provide an alarm during an emergency and/or in response to other conditions sensed by the sensor(s). For example, some systems 500 include a transducer 540 comprising a capacitive micromachined ultrasound transducer (CMUT) or a piezoelectric micromachined ultrasound transducer (PMUT). The transducer 540 may be driven in a particular frequency range to provide audible signals. The transducer 540 may be driven in a second frequency range outside of human hearing and, in that second range, provide mechanical vibration to the sensor element 520 or other components of the device.

In operation, the system 500 may operate to apply heat and vibration to the sensor element 520 at the same time. In this manner, dirt, insects, and/or other contaminants may be dislodged from the sensor element 520. As shown in FIG. 5, if the sensor element 520 is mounted to hang from the PCB 510, the force of gravity may also operate to remove contaminants from the sensor element 520 once dislodged by the operation of the system 500.

We claim:

1. A system comprising:
a sensor element;
a mechanical transducer to vibrate the sensor element; and
a heating element to provide localized heat to the sensor element;
wherein the heating element and the mechanical transducer operate in concert to raise a temperature of the sensor element and vibrate the sensor element to dislodge contaminants from a surface of the sensor element.

2. The system of claim 1, further comprising:
a housing with a mounting surface;
a controller to actuate the mechanical transducer and activate the heating element;
wherein the sensor element and the mechanical transducer are mounted to the mounting surface;
wherein actuating the mechanical transducer vibrates the mounting surface and thereby vibrates the sensor element.

3. The system of claim 1, wherein the sensor element and the heating element are at least partially integrated in a single integrated circuit.

4. The system of claim 1, wherein the sensor element, the heating element, and the mechanical transducer are at least partially integrated in a single integrated circuit.

5. The system of claim 1, wherein:
the sensor element includes an active surface;
when the system is deployed, the active surface faces downward with respect to gravity.

6. The system of claim 1, further comprising:
a controller to actuate the mechanical transducer and activate the heating element; and
a source of compressed fluid to supply a fluid flow onto the sensor element;
wherein the controller activates the source of compressed fluid to deliver fluid to the surface of the sensor element.

7. The system of claim 1, wherein:
the sensor element includes at least one photodiode and at least one light emitting diode; and
the heating element applies heat to leads of the at least one light emitting diode.

8. The system of claim 1, wherein the sensor element comprises an element responsive to a change in a concentration of a sensed gas and/or chemical.

9. The system of claim 1, wherein the sensor element is responsive to a change in a concentration of a gas, the gas selected from the group consisting of: carbon monoxide, methane, nitrogen dioxide, or water vapor.

10. A system comprising:
a sensor element;
a housing surrounding the sensor element to reduce contamination reaching the sensor;
a mechanical transducer to vibrate the housing; and
a heating element to provide localized heat to the housing;
wherein the heating element and the mechanical transducer operate in concert to raise a temperature of the housing and vibrate the housing to dislodge contaminants from a surface of the housing.

11. The system of claim 10, further comprising:
a second housing;
a controller to actuate the mechanical transducer and activate the heating element;
wherein the housing is mounted in an interior of the second housing;
wherein the mechanical transducer is mounted to the second housing.

12. The system of claim 10, further comprising:
a controller to actuate the mechanical transducer and activate the heating element; and
a source of compressed fluid to supply a fluid flow to a housing;
wherein the controller activates the source of compressed fluid to deliver fluid to the surface of the housing.

13. The system of claim 10, wherein the sensor element comprises an element responsive to a change in a concentration of a sensed gas and/or chemical.

14. The system of claim 10, wherein the sensor element is responsive to a change in a concentration of a gas, the gas selected from the group consisting of: carbon monoxide, methane, nitrogen dioxide, or water vapor.

15. A method for cleaning a sensor element comprising:
vibrating the sensor element with a mechanical transducer; and
providing localized heat to the sensor element with a heating element to raise a temperature of the sensor element;
wherein the mechanical transducer and the heating element are operated in concert to dislodge contaminants from a surface of the sensor element.

16. The method of claim 11, wherein:
the sensor element and the mechanical transducer are mounted to a mounting surface of a housing; and
a controller actuates the mechanical transducer to vibrate the mounting surface and thereby vibrates the sensor element.

17. The method of claim 11, wherein the heating element is at least partially integrated in the sensor element.

18. The method of claim 11, wherein:
the sensor element includes an active surface; and
when the system is deployed, the active surface faces downward with respect to gravity.

19. The method of claim 11, further comprising activating a source of compressed fluid to supply a fluid flow onto the sensor element.

20. The method of claim 11, wherein the sensor includes at least one photodiode and at least one light emitting diode; and
applying heat to the sensor includes heating leads of the at least one light emitting diode.
